(19) United States
(12) Patent Application Publication
(10) Pub. No.: US 2015/0141103 A1
(43) Pub. Date: May 21, 2015

(54) TOPIC RELATED PHRASE GAME

(71) Applicant: Matthew Steven Gallagher, South Paris, ME (US)

(72) Inventor: Matthew Steven Gallagher, South Paris, ME (US)

(21) Appl. No.: 14/083,709

(22) Filed: Nov. 19, 2013

(51) Int. Cl. A63F 13/46

(52) U.S. Cl. CPC A63F 13/46
USPC 463/9

(57) ABSTRACT

The techniques described herein determine a game topic for a phrase game. Players of the phrase game may take turns submitting a phrase to a game board to earn a turn score (e.g., points or other form of value) which is added to a total, running game score. A submitted phrase played may be determined to be associated with the game topic determined for the phrase game. For instance, the game topic may include a topic phrase list that lists a plurality of phrases individually assigned a value based on an association between a phrase and the game topic. The assigned value provides an adjustment for a player turn score. For instance, the value may comprise bonus points added to regular turn points that result from the player turn score. Or, the value may be a bonus multiplier that multiplies (e.g., doubles, triples, etc.) the regular turn points.

### BACKGROUND

Conventional word games allow players to submit any word to a game board for points. For instance, a player may submit the word “play” when it is the player's turn. The points earned by the player are typically based on points assigned to individual letters. For example, the “p” may be assigned three points, the “l” may be assigned two points, the “a” may be assigned one point, and the “y” may be assigned four points. Accordingly, after submitting “play” to the game board for a turn, the player earns ten points (e.g., a combination of individual letter points that comprise the word). The ten points are a turn score which are added to a running, total game score. In some instances, the points for a turn may be adjusted if letters are placed on a particular location of the game board (e.g., double letter spot, triple letter spot, double word spot, triple word spot, etc.).

The conventional word games typically use a standard dictionary, such as the “North American Benchmark Lexicon”, to determine whether submitted letters constitute an acceptable word. The standard dictionaries include a variety of words, and thus, players of conventional word games have a variety of playing options as they are able to play any known word for points.

### BRIEF DESCRIPTION OF THE DRAWINGS

The detailed description is presented with reference to accompanying figures. In the figures, the left-most digit(s) of a reference number identifies the figure in which the reference number first appears. The use of the same reference numbers in different figures indicates similar or identical items.

FIG. 1 illustrates an example environment that allows players to play a topic related phrase game, in accordance with various embodiments.

FIG. 2 illustrates an example computing device that may comprise, or be part of, a game system that hosts the topic related phrase game, in accordance with various embodiments.

FIG. 3 illustrates an example player device used by a player to play the topic related phrase game, in accordance with various embodiments.

FIG. 4. illustrates an example process that creates a topic that may then be assigned to a gameplay instance of the topic related phrase game, in accordance with various embodiments.

FIG. 5 illustrates an example process that creates a gameplay instance of the topic related phrase game with an assigned topic, in accordance with various embodiments.

FIG. 6 illustrates an example process that scores an individual turn after a player submits a phrase in the topic related phrase game, in accordance with various embodiments.

### DETAILED DESCRIPTION

The techniques described herein determine a game topic for a phrase game. Players of the phrase game may take turns submitting a phrase to a game board to earn a turn score (e.g., points or other form of value) which is added to a total, running game score. A submitted phrase played may be determined to be associated with the game topic determined for the phrase game. For instance, the game topic may include a topic phrase list that lists a plurality of phrases that are individually assigned a value based on an association between a phrase and the game topic. The assigned value provides an adjustment for a player turn score. For instance, the value may comprise bonus points added to regular turn points that result from the player turn score. Or, the value may be a bonus multiplier that multiplies (e.g., doubles, triples, etc.) the regular turn points that result from the player turn score.

As used herein, an individual topic defined for, or assigned to, an instance of a topic related phrase game may comprise any one of a variety of topics and an individual topic may vary between a general topic and a more specific topic. For example, the game topic may be “sports” and may include phrases commonly related to, and/or commonly associated with, all sports (e.g., basketball, football, soccer, baseball, volleyball, etc.). Or the game topic may be an individual sport and thus, the related or associated phrases with assigned values that adjust the score (e.g., bonus points, bonus multipliers, etc.) may be limited to phrases associated with that individual sport. For instance, if the topic is football than a list of football phrases may include “quarterback”, “linebacker”, “touchdown”, “fieldgoal”, “firstdown”, etc. Other examples of topics may include professions (e.g., law, medical, teaching, etc.), television shows (e.g., favorite sitcoms, popular reality television shows, etc.), movies, music (e.g., a particular musician, a genre of music, etc. and so forth. As provided in the examples above, any subject may be defined as a topic for a game as long as the subject has a sufficient list (e.g., more than twenty phrases) of associated phrases to sustain the game where players alternate turns submitting phrases.

The topic may be defined by a developer of the game and after determining a game topic the developer may define a set of phrases associated with the topic. In some instances, a topic phrase list may include phrases that are connected to the game topic, but may not be considered lexical phrases or words. For example, if the game topic is social media communications then phrases included in the topic phrase list may include “LOL”, “Chillaxin” and/or “OMG”.

A player's goal for the game is to accumulate more points than an opponent or opponents (e.g., the other players). Thus, by defining a game topic and providing value for played phrases associated with the game topic, the techniques described herein allow players to earn additional value (e.g., bonus value) assigned to individual phrases in addition to a regular score earned for submitting the phrase as described above with respect to the conventional word games. As discussed above, the regular score in conventional word games is based on a combination of individual letter points and any value added from a placement location (e.g., double word spot on the game board, triple word spot, double letter spot, triple letter spot).

By introducing a game topic to instances of a phrase game, the players may experience a renewed interest in each instance of the phrase game played. That is, since the game topic may change from one instance of the gameplay to the next, players may be presented with a new challenge. Conventional word games allow players to play any word defined in a standard dictionary (e.g., the “North American Benchmark Lexicon”), but do not provide score adjustments based on a phrase's association with a game topic determined for the phrase game.

In various embodiments, the game topics and their topic phrase lists along with the assigned values to phrases are stored in an accessible phrase game database. The phrase game database may be accessed by a game system providing a gameplay instance of the topic related phrase game to a player. Information (e.g., the game topic, the topic phrase list and the assigned values for the phrases) in the phrase game database may also be made accessible to the players of the game in accordance with one or more phrase game rules. In other words, the phrase game database may comprise multiple game topics that each includes a list of phrases that may provide bonus value if a player submits a phrase associated with the game topic as opposed to a phrase that is not associated with the game topic (e.g., a word defined in a standard dictionary).

Moreover, the techniques described herein provide a platform to create or add a game topic to a set of game topics. Therefore, players may be provided with a variety of different topics and they can select topics they are interested in or topics that may challenge them or their opponents. In some embodiments, the host game system may create the game topics. For example, game developer may identify topics and create a list of associated phrases for each topic. In alternative embodiments, the host game system may provide a platform for third parties to submit a phrase topic and a list of phrases and/or their assigned values. For instance, the host game system may license (e.g., for a fee) the phrase game to a particular person (e.g., a celebrity, a movie star, a sports star), a particular product (e.g., a movie, a television show, a sports team), a particular place (e.g., an amusement park, a water park, etc.). Therefore, the third party may provide a list of phrases, as well as values, to be associated with the game topic.

As further discussed herein, the techniques may determine that a submitted phrase is mapped to a pre-defined bonus score for the phrase. Rules of the game may indicate that the pre-defined bonus score is earned by a player based on an association between a phrase and a game topic, as discussed above. Therefore, the techniques described herein allow value to be provided to a player based on a phrase played. The pre-defined bonus score may be the same for all play instances of the phrase (e.g., different turn plays in the same game or different games). In various embodiments, the value for the phrase may be the same based on various forms of the phrase (e.g., “fix”, “fixed”, “fixes”, etc.) In alternative embodiments, the value for a phrase may be different for the various forms of the phrase (e.g., a first value for “fix”, a second value for “fixed”, and a third value for “fixes”). Thus, the pre-defined bonus score may be independent of the actual letters used in the word and independent of a location of a game board where the letters are placed. This is in contrast to conventional word games, where the value cannot be determined until after the phrase is submitted during a gameplay instance. For example, in conventional word games, the terms “fixes” and “fixed” earn different amounts of points based on the different letters used. Moreover, two different instances of a player submitting “fix” may be scored differently based on game board location-based bonuses (e.g., triple word spot, double letter spot, etc.).

The phrases played or submitted by the players of the phrase game may include, but are not limited to, a single word commonly used in association with the topic of the game, multiple words commonly used in association with the topic of the game, an acronym commonly used in association with the topic of the game, one or more terms given a specific meaning that is commonly used in association with the topic of the game, an abbreviation commonly used in association with the topic of the game, and/or any string of letters that may be commonly associated with the game topic.

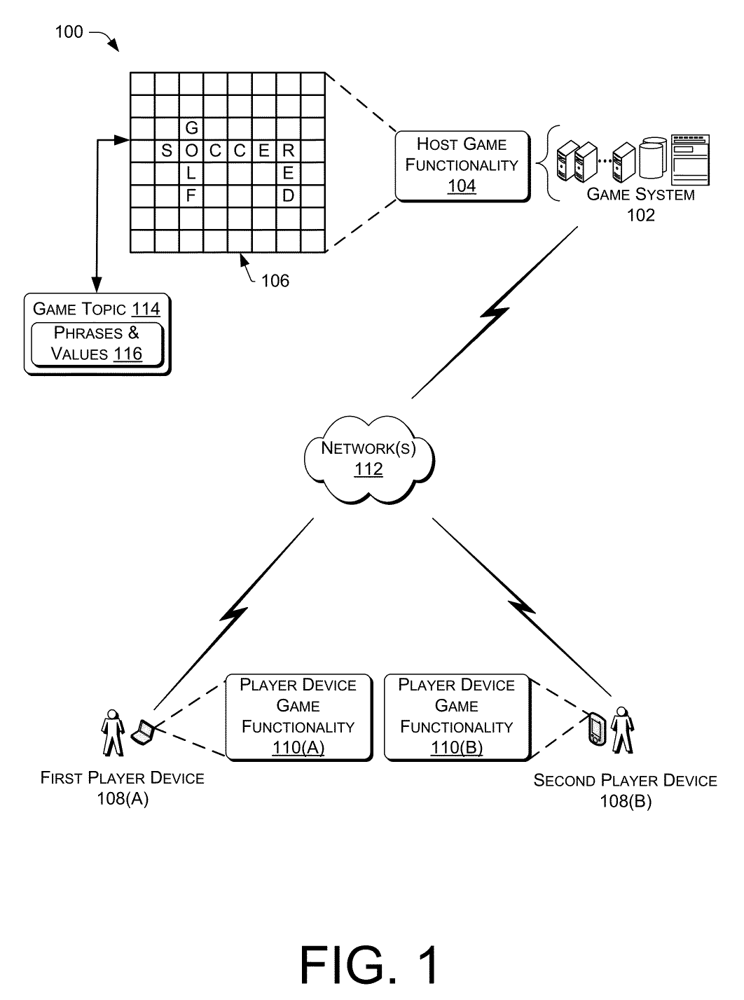

FIG. 1 illustrates an example environment 100 of a game system 102 that executes host game functionality 104 configured to create or initiate an instance of a topic related phrase game where a first player and a second player individually submit phrases to a game board 106 (e.g., the players alternate turns to submit a phrase). As shown in FIG. 1, the first player may use a first player device 108(A) that executes player device game functionality 110(A) (e.g., a phrase game application “app”) that enables the first player to play the phrase game. That is, the first player may use the first player device 108(A) to submit a phrase to, or play a phrase on, the game board 106. Similarly, the second player may use a second player device 108(B) that executes player device game functionality 110(B) to submit a phrase to, or play a phrase on, the game board 106. In various embodiments, the first player device 108(A) and the second player device 108(B) may be different devices or the same device.

Although FIG. 1 shows two players participating in the phrase game and competing with each other, it is understood in the context of this document, that the host game functionality 104 may allow more than two players to participate and compete with one another in a single gameplay instance (e.g., three players, four players and so forth). Moreover, in alternative embodiments, the host game functionality 104 may comprise one of the two players (e.g., a real-world player may play the computer which operates a virtual player).

The game system 102 may comprise, or be part of, a content provider and/or a service provider that allow players to play the phrase game with each other over one or more network(s) 112. The one or more network(s) 112 may include one or a combination of the Internet, a Wide Area Network (WAN), a Local Area Network (a LAN), a Mobile Telephone Network (MTN) or other various communication technologies (e.g., wired and/or wireless). Accordingly, the game system 102 may communicate with the first player device 108(A) and the second player device 108(B) via the one or more network(s) 112.

As discussed above, the host game functionality 104 may create a game board 106 for each instance of the phrase game (e.g., a gameplay instance). The gameplay instance may have a governing game topic 114 determined (e.g., selected, assigned) for the game, the game topic 114 including a list of topic phrases, each phrase being associated with a value 116. The host game functionality 104 is configured to determine whether or not a phrase submitted by a player is associated with (e.g., maps to) the game topic and may determine a phrase value used to modify a player's turn score if the phrase is associated with the game topic. In various embodiments, the phrase value determined by the host game functionality 104 adjusts a regular turn score that may be calculated similar to those of conventional word games (e.g., based on a combination of letter values and letter placement on the game board 106).

To implement the topic related phrase game, the host game functionality 104 may include a host bank of letters configured in accordance with phrase game rules. For example, the host bank of letters may include ten instances of the letter “A”, three instances of the letter “B”, two instances of the letter “C” and so forth. The number of instances of individual letters may vary in accordance with the phrase game rules and often there are fewer instances of letters that are not commonly used in a dictionary (e.g., “X” and “Z”) and more instances of letters that are more commonly used in a dictionary (e.g., “A”, “E”, “I”, “O”). Similar to conventional word games, each letter may include an individual letter value that is used to calculate a turn score when played (e.g., the regular turn score referred to above).

At the start of the game, the host game functionality 104 initially distributes a number of letters (e.g., five, six, seven, eight, nine, ten, etc.) from the host bank of letters to a player bank of letters associated with each of the players. As the game progresses, the host game functionality 104 replenishes the player bank of letters as the players submit phrases in turn. For example, the first player may use her bank of letters to play “golf” on the game board 106 and then the host game functionality 104 may randomly select another four letters from the host bank of letters and distribute them to the first player's bank of letters. The second player may then use his/her bank of letters to play “soccer” on the game board 106 and may receive another six letters from the host game functionality 104. The first player may then user her bank of letters to play “red” on the game board. The players alternate turns to earn turn points and accumulate a total game score until a winner is declared (e.g., when the host bank of letters is exhausted and there are no more letters to distribute).

As discussed above, in addition to a regular turn score determined based on individual letter values, the techniques described herein allow a player to earn additional turn value based on a phrase played. This additional turn value is based on a complete phrase and is separate from the individual letter values and the location-based placement bonuses (e.g., a double letter spot on the game board 106) that ultimately constitute a regular turn score. The additional turn value may be based on a phrase's association to an assigned game topic 114.

In the example environment of FIG. 1, if the game topic 114 defined is “sports”, then the phrases “golf” and “soccer” may individually be listed in the phrases and values 116 since golf and soccer are both phrases that correspond to sports. In contrast, the phrase “red” may not be commonly associated with a sport, and therefore, the player that submitted the phrase “red” may not receive a value (e.g., a topic related phrase bonus) for playing the phrase “red” when the game topic 114 for the instance of the phrase game is sports.

The size of the game board 106 may vary in accordance with the rules of the phrase game. For example, the size may be a 14×14 board (each unit or spot on the game board 106 allows placement of a single letter), a 20×20 board, a 20×30 board, etc. The size may depend on any one of various factors such as size of a display screen of a device. Moreover, similar to conventional word games, the game board 106 may include game board location based multipliers that depend on a location of letter placement on the game board 106 (e.g., double letter spot, triple letter spot, double word spot, triple word spot, etc.).

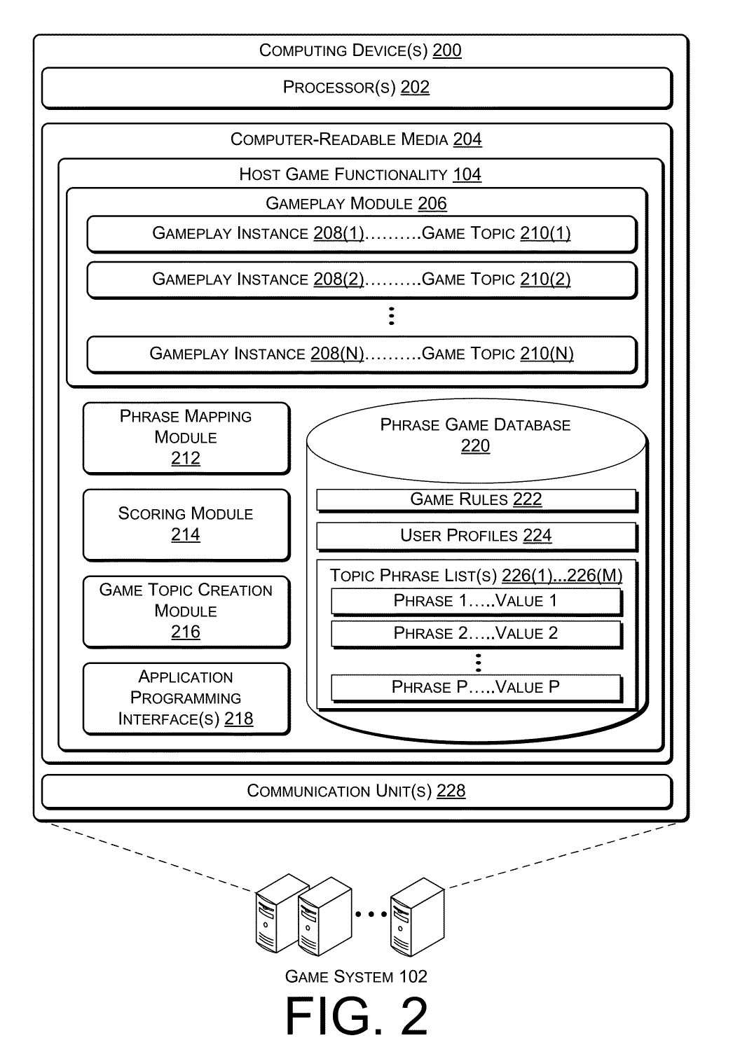

FIG. 2 illustrates an example computing device 200 that may comprise, or be part of, the game system 102. The computing device 200 may be a data server (e.g., a Web server, a game server, a social network server, a cloud server, a file transfer server, etc.) or any other electronic device that can operate the host game functionality 104 and/or communicate with the first player device 108(A) and the second player device 108(B) over the one or more network(s) 112 so the players can create a gameplay instance and play the topic related phrase game. In some embodiments, the game system 102 may include multiple computing devices 200 (e.g., a server farm, cloud computing, etc.).

The computing device 200 may comprise one or more processors 202 and computer-readable media 204. The processor(s) 202 may be a single processing unit or a number of units, each of which could include multiple different processing units. The processor(s) may include a microprocessor, a microcomputer, a microcontroller, a digital signal processor, a central processing unit (CPU), a graphics processing unit (GPU), a security processor etc. Alternatively, or in addition, some or all of the techniques described herein can be performed, at least in part, by one or more hardware logic components. For example, and without limitation, illustrative types of hardware logic components that can be used include a Field-programmable Gate Array (FPGA), an Application-specific Integrated Circuit (ASIC), an Application-specific Standard Products (ASSP), a state machine, a Complex Programmable Logic Device (CPLD), other logic circuitry, a system on chip (SoC), and/or any other devices that perform operations based on instructions. Among other capabilities, the processor(s) 202 may be configured to fetch and execute computer-readable instructions stored in the computer-readable media 204.

As used herein, “computer-readable media” includes computer storage media and communication media. Computer storage media includes volatile and non-volatile, removable and non-removable media implemented in any method or technology for storage of information, such as computer-readable instructions, data structures, program modules, or other data. Computer storage media includes, but is not limited to, random access memory (RAM), read only memory (ROM), electrically erasable programmable ROM (EEPROM), flash memory or other memory technology, compact disk ROM (CD-ROM), digital versatile disks (DVD) or other optical storage, magnetic cassettes, magnetic tape, magnetic disk storage or other magnetic storage devices, or any other medium that can be used to store information for access by a computing device.

In contrast, communication media may embody computer-readable instructions, data structures, program modules, or other data in a modulated data signal, such as a carrier wave. As defined herein, computer storage media does not include communication media.

The computer-readable media 204 comprises the host game functionality 104 of FIG. 1. As further shown in FIG. 2, the host game functionality 104 may include a gameplay module 206 that manages different gameplay instances 208(1) . . . 208(N). Each gameplay instance 208(1) . . . 208(N) represents a topic related phrase game played between two players (e.g., one real-world player and one virtual player, two real-world players, more than two real-world players, etc.) and each gameplay instance 208(1) . . . 208(N) may be associated with a separate game topic 210(1) . . . 210(N) that has been determined for the gameplay instance. For example, the players may select the game topics 210(1) . . . 210(N) when creating the gameplay instances 208(1) . . . 208(N) or the host game functionality 104 may automatically assign a game topic 210(1) . . . 210(N) to individual gameplay instances 208(1) . . . 208(N). Accordingly, each gameplay instance 208(1) . . . 208(N) has its own game board (e.g., the game board 106 from FIG. 1) and the gameplay module 206 may be operating any number N of instances of the topic related phrase games currently being played at a given time (e.g., tens, hundreds, thousands of games). Of course the number of instances N may depend on a number of registered users of a topic related phrase game application and their participation levels.

In various embodiments, the host game functionality 104 further may comprise a phrase mapping module 212, a scoring module 214, a game topic creation module 216, one or more application programming interface(s) (APIs) 218 and/or a phrase game database 220. The phrase game database 220 may include game rules 222, user profiles 224, and various topic phrase lists 226(1) . . . 226(M) (e.g., a list associated with game topic 114 from FIG. 1). The topic phrase lists 226(1) . . . 226(M) individually list a number of phrases P, where each phrase is assigned a value (P may vary from game topic to game topic depending on a number of phrases defined to be associated with the game topic).

As discussed above, the game rules 222 may govern the implementation of the game and may define particular game specifications. For example, the game rules 222 may indicate the size of the board 106 (e.g., 30×30), individual letter values, placement of letter location bonuses on the game board 106, number of letters in the host letter bank to distribute to players, the number of letters accessible to an individual player via the player letter bank. In some embodiments, particular rules may be adjustable and/or selectable by a player of the topic related phrase game.

Additionally, the game rules 222 may also define rules associated with a game topic assigned to a gameplay instance of the topic related phrase game. For example, the game rules 222 may define that phrases listed in the topic phrase lists 226(1) . . . 226(M), and their assigned values, may be accessible to the players during the gameplay (e.g., players can view the phrases and their values before determining a phrase to submit to the game board 106 when it's their turn.). In another example, the game rules 222 may define that phrases listed in the topic phrase lists 226(1) . . . 226(M), and their assigned values, may not be accessible to the players during the gameplay. In yet another example, the game rules 222 may define that factors used to determine the assigned values for phrases may be provided, but not the actual phrases or values. For instance, in accordance with this last example, players may be informed that phrases more commonly used in association with a topic have a higher value as opposed to phrases less commonly used in association with the topic. Or, players may be informed that phrases more commonly used in association with a topic have a lower value as opposed to phrases less commonly used in association with the topic. In some instances, the amount of information accessible to the players may be user-selectable before playing the topic-related phrase game.

As further discussed herein, the gameplay module 206, the phrase mapping module 212, the scoring module 214 and/or the game topic creation module 216 may access the information stored in the phrase game database 220 to host the gameplay instances 208(1) . . . 208(N).

For instance, in various embodiments, the gameplay module 206 receives a request from a user that has registered a user profile 224. The request may indicate that the user wants to challenge another registered user to a topic relate phrase game. Accordingly, the gameplay module 206 may send an indication or notification to the other register user and, upon acceptance, may create a gameplay instance. The gameplay module 206 may then determine a game topic. For example, the gameplay module 206 may automatically select and/or assign a game topic without user input. Or, the game play module 206 may recommend a game topic and/or receive a user selection of a game topic.

In various embodiments, the host game functionality 104 may access, via APIs 218 and in accordance with user and/or system permissions, information associated with the registered users. This information may include messaging information (e.g., key-words of messages, topics of messages), social networking information, calendar information (e.g., appointment time, attendees), gaming information, browsing information, Web searching information, image information, purchase information (e.g., books, movie tickets, sport game tickets), digital video recorder information (e.g., recorded programs), etc. The host game functionality may store this information in the user profiles 224 and the information can be used to recommend a game topic. Moreover, the user profiles 224 may include information related to previous topics for a player so that the player continually experiences new game topics for different gameplay instances. This will prevent the assignment of repeat game topics or game topics with which the user is familiar.

As the players (e.g., the first player and the second player from FIG. 1) alternate turns submitting phrases to a game board, the phrase mapping module 212 may determine whether or not a submitted phrase maps to a phrase in one of the topic phrase lists 226(1) . . . 226(M) (e.g., for the game topic 114 assigned to the gameplay instance). If the phrase mapping module 212 determines that the submitted phrase is associated with the game topic, it extracts a value for the phrase and communicates the value to the scoring module 214. At that point, the scoring module 214 uses the value to adjust the player's regular turn score. As discussed above, the regular turn score may be based on a combination of points based on individual letters used in the phrase and/or game board location based bonuses (e.g., double word spot, triple word spot, etc.). The scoring module 214 may use the retrieved value associated with the phrase to adjust the regular turn score. For instance, the value may be a multiplier of the regular turn score (e.g., integer multipliers such as 2, 3, 4, etc. or decimal multipliers such as 1.5, .8, etc.). Thus, if the regular turn score resulted in twelve points and the multiplier value for the phrase is “two”, the total turn score would be twenty-four. In another example, the value may be a fixed amount of points (e.g., 2, 3, 4, 5, 6, 6.5, etc.). Thus, if the regular turn score resulted in twelve points and the fixed point value is “two”, the total turn score would be fourteen points. It is understood in the context of this document that the scoring formats provided above are examples only, and that any other scoring or value-added mechanisms may be used to increase a player's turn score based on a phrase played. In some instances, the bonus may be a negative bonus (e.g., a multiplying value of 0.8).

The phrases in the topic phrase lists may be 226(1) . . . 226(M) may be organized in various formats. For instance, the phrases may be listed in alphabetical order, may be sorted by value (e.g., highest to lowest or lowest to highest), or may be sorted based on length of the phrase or the base phrase (e.g., fix is the base phrase for fixes, fixing and fixed). This may help the players when they access the topic phrase lists may be 226(1) . . . 226(M) to determine if a particular phrase has an association with the game topic. In some instances, an individual topic (e.g., a more general topic such as “law”) may be split up into multiple sub-topics (e.g., more specific such as “intellectual property law”, “corporate law”, “maritime law”, etc.). In various embodiments, the value assigned to phrases in the general topic may depend on one or more sub-topics to which the phrases are associated.

In various embodiments, the computing device 200 includes one or more communication unit(s) 228 to facilitate a wired and/or wireless connection to a network and/or other devices. Therefore, the communication unit(s) 228 may implement one or more of various wired and/or wireless technologies, such as Internet communications, Wi-Fi communications, Bluetooth communications, radio frequency (RF), USB communications, broadband connections, optical port, Ethernet, mobile telephone network (MTN) communications or any other acceptable communications protocol.

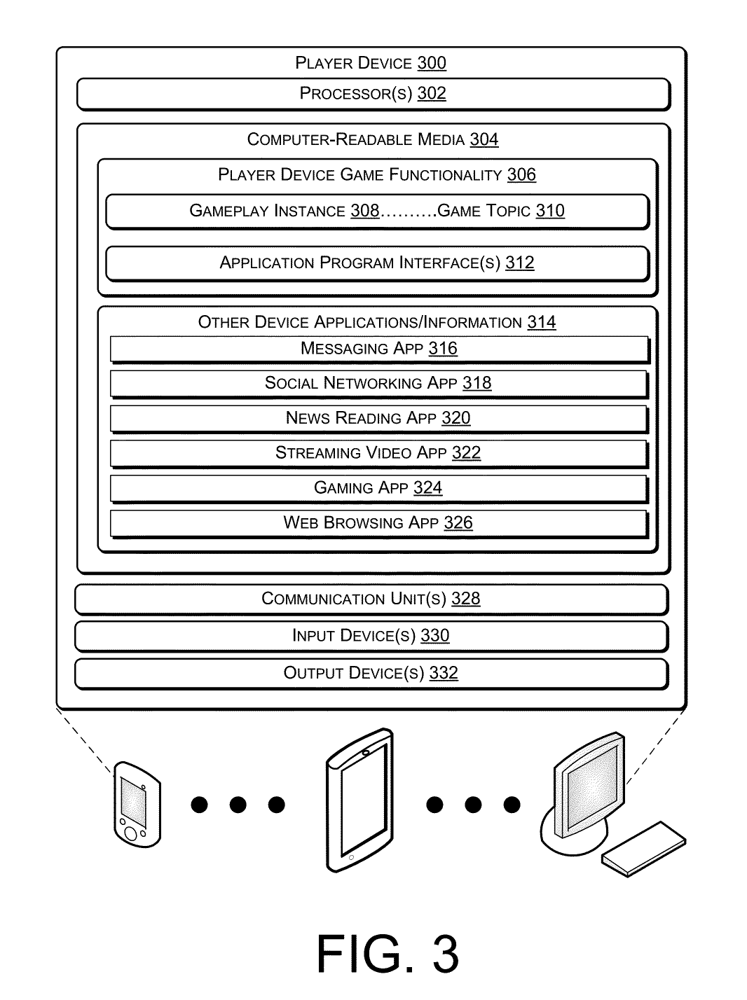

FIG. 3 illustrates an example player device 300 (e.g., the first player device 108(A) or the second player device 108(B) from FIG. 1). The player device 300 may include, but is not limited to, a smartphone, a mobile phone, a cell phone, a tablet computer, a portable computer, a laptop computer, a desktop computer, a personal digital assistant (PDA), an electronic book device, a gaming console, a personal media player device, a set top box, a digital video recorder or any other electronic device that may exchange (e.g., receive and/or transmit) data over the one or more network(s) 112. The player device 300 may comprise one or more processor(s) 302 and computer-readable media 304. The processor(s) 302 may comprise the example processors discussed above with respect to FIG. 2 and the computer-readable media 304 may comprise the computer-readable media discussed above with respect to FIG. 2.

The computer-readable media 304 may include player device game functionality 306 (e.g., the player device game functionality 110(A) or 110(B) from FIG. 1). In various embodiments, the player device game functionality 306 is a gaming application that allows a user of the player device 300 (e.g., a player) to partake in playing the topic related phrase game described herein. Therefore, the player device game functionality 306 may operate a player device gameplay instance 308 associated with a game topic 310. The player device gameplay instance 308 may be one of the gameplay instances 208(1) . . . 208(N) discussed above with respect to FIG. 2. The player device game functionality 306 may operate more than one player device gameplay instance 308 (e.g., multiple gameplay instances) if the user of the player device 300 is participating in more than one topic related phrase game at a given time (e.g., multiple games with the same opponent or multiple games with different opponents).

In various embodiments, the player device game functionality 306 may include player device APIs 312. The player device APIs 312 may be configured to access, in accordance with settings and user permissions, other device applications (“apps”) and information 314. The player device APIs 312 may access applications and information 314 stored locally on the player device 300 or the player device APIs 312 may access applications and information stored remotely on other devices associated with a user. For example, the other device applications may include, but are not limited to, a messaging app 316, a social networking app 318, a news reading app 320, a streaming video app 322, another gaming app 324, a web browsing app 326 and so forth.

In various embodiments, the player device APIs 312 may access the other device applications and information 314 to determine user interests and correlate (e.g., match) a game topic to the user interests. For example, the player device APIs 312 may determine, based on an analysis of keywords, that a user has recently been messaging (e.g., texting, social media messaging, emailing) friends or contacts about a popular television show or movie. Thus, the player device APIs 312 may provide information to the player device game functionality 306 and/or the host game functionality 104 and the player device game functionality 306 and/or the host game functionality 104 may then recommend the popular television show or movie as a topic. Of course, the popular television show or movie would be a game topic with a topic phrase list 226(1) . . . 226(M). In another example, the player device APIs 312 may determine that a user has recently posted self images playing football, that the user played a football gaming app, or that a calendar appointment indicates the user is to attend a professional football game. Thus, the player device APIs 312 may provide this information to the player device game functionality 306 and/or the host game functionality 104 and the player device game functionality 306 and/or the host game functionality 104 may then recommend football as a topic for the phrase game.

In some embodiments, some or all of the information stored in the phrase game database 220 of FIG. 2 may be located on the player device 300 and the player device game functionality 306 may be configured to operate one or more of the phrase mapping module 212, the scoring module 214 and the game topic creation module 216. Thus, the functionality described above with respect to FIG. 2 may be shared between the game system 102 and the player device 300. In some implementations, a network connection may not be required to play the topic related phrase game. For example, all the functionality may be located locally on a single player device 300 and two players can play each other on the single player device 300 or a player can play a virtual opponent (e.g., play the computer) on the single player device 300.

Furthermore, the player device 300 may include one or more communication unit(s) 328 to facilitate a wired and/or wireless connection to a network or other devices. Therefore, the communication unit(s) 328 may implement one or more of various wired and/or wireless technologies, such as Internet communications, Wi-Fi communications, Bluetooth communications, radio frequency (RF), USB communications, broadband connections, optical port, Ethernet, mobile telephone network (MTN) communications or any other acceptable communications protocol. The player device 300 may also include one or more input device(s) 330 and one or more output device(s) 332. The input device(s) 330 may include a keyboard, a keypad, a mouse, a touch screen, a touch pad, a joystick, control buttons, scrolling buttons, page flipping buttons, microphones, etc. The input device(s) may enable a player to input a phrase (e.g., plays a phrase on game board 106). The output device(s) 332 may include a display (e.g., touch screen, computer monitor, liquid crystal display (LCD), etc.), speakers, or the like. The output device(s) 332 may enable a player to view the game board 106 and/or other game information (e.g., name of opponent, total game score for each player, etc.).

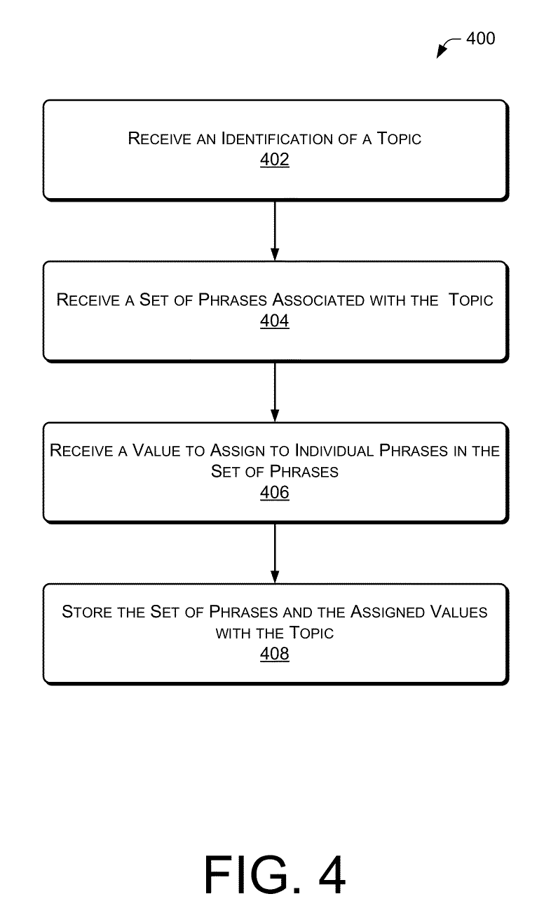

Example operations are described herein with reference to FIGS. 4-6. The processes are illustrated as logical flow graphs, which represent a sequence of operations that can be implemented in hardware, software, firmware, or a combination thereof In the context of software, the operations represent computer-executable instructions that, when executed by one or more processors, perform the recited operations. Generally, computer-executable instructions include routines, programs, objects, components, data structures, and the like that perform particular functions or implement particular abstract data types. In some embodiments, any or all of the operations may be implemented in whole or in part by hardware (e.g., as an ASIC, a specialized processing unit, etc.) to execute the described functions. The order in which the operations are described is not intended to be construed as a limitation, and any number of the described operations can be combined in any order and/or in parallel to implement the processes. Moreover, the example operations in FIGS. 4-6 may be described with reference to the example modules, components and/or elements illustrated in FIGS. 1-3. However, the example operations in FIGS. 4-6 may be implemented in other systems and/or devices as well.

FIG. 4 illustrates an example process 400 that creates a topic that may then be used to govern a gameplay instance. The example process 400 may be implemented by the game system 102 and/or the host game functionality 104. For example, a developer of the game system 102 may create the topics and the phrases/values (e.g., enter a topic, the associated phrases and their values). In another example, third party entities (e.g., companies, representatives of celebrities, etc.) may use a platform of the game system 102 to provide input that identifies a topic and to create the phrases/values.

At 402, the host game functionality 104 receives an identification of a topic of a game. For example, the topic may be football or a particular television show.

At 404, the host game functionality 104 receives a set of phrases associated with the topic of the game identified in 402. For example, if the topic is football the phrases may be “quarterback”, “punter”, “touchdown”, “fieldgoal”, etc. If the topic is the particular television show, the phrases may be characters of the show, the city the show is located in, places (e.g., schools, retail stores) in the show, etc. In various embodiments, the game rules 222 may define a minimum number of phrases (e.g., twenty phrases) and/or a maximum number of phrases (e.g., one thousand phrases) for a single topic. In various embodiments, the host game functionality 104 may perform an online search to locate phrases associated with a particular topic.

At 406, the host game functionality 104 receives a value assigned to each individual phrase in the set of phrases based on an association between an individual phrase and the topic of the game. When assigning a value to a phrase (e.g., a developer may assign a value), one or more factors may be considered. The factors include, but are not limited to, a difficulty of spelling the phrase, a number of letters in the phrase, a difficulty of pronunciation, a popularity of the phrase, how common the phrase is used in association with the topic, or a relevance of the phrase based on importance within the topic. In some instances, the factors may be subjectively considered (e.g., by a developer or by a third-party entity to determine the value).

For example, “quarterback” may receive a higher value than “punter” because a quarterback is known to be more important in the game of football than the punter. Moreover, “quarterback” includes more letters and one may argue, is more difficult to spell. In another example, “touchdown” may receive a higher value than “fieldgoal” because a touchdown is worth six points and a field goal is worth three in the game of football.

At 408, the host game functionality 104 stores the set of phrases and the values assigned to the individual phrases in the phrase game database 220 so that the topic can be used in various gameplay instances 208(1) . . . 208(N).

The example process of FIG. 4 may be repeated for multiple different topics so that a larger selection of topics is created and/or made available to the registered players of the topic related phrase game (e.g., an app).

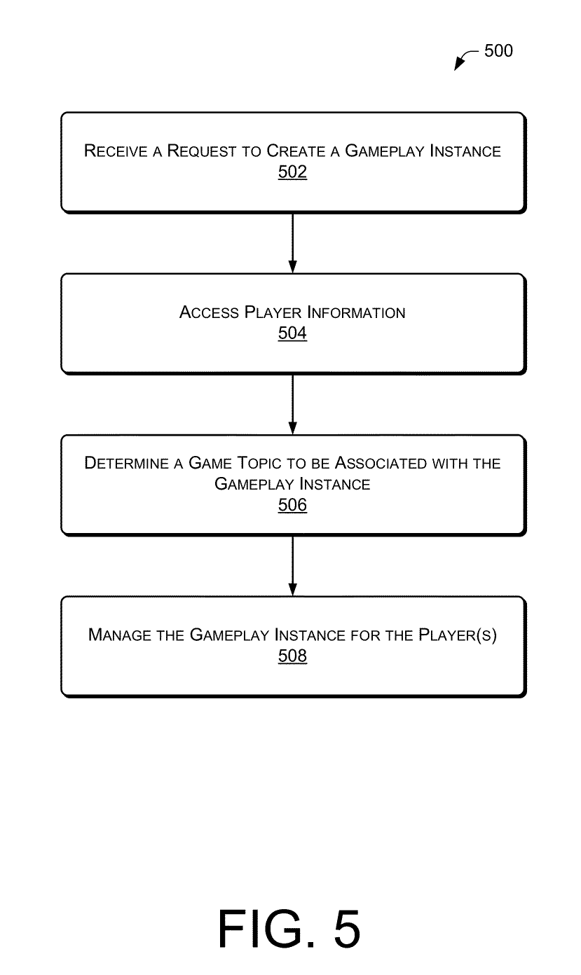

FIG. 5 illustrates an example process 500 that creates a gameplay instance with an assigned topic for two players (e.g., the first player and the second player from FIG. 1).

At 502, the host game functionality 104 receives a request to create a gameplay instance. For example, a first player may challenge a second player to play the topic related phrase game. At 504, the host game functionality 104 may access player information stored in the user profiles 224.

At 506, the host game functionality 104 may use the information in the user profiles 224 to determine a game topic to be associated with the gameplay instance. In various embodiments, the host game functionality 104 may automatically assign/select a game topic (e.g., based on interests in the user profiles 224). In various embodiments, the host game functionality 104 can provide a list of recommended game topics (e.g., based on interests in the user profiles 224) and receive a user-selection from a player.

At 508, the host game functionality 104 manages the gameplay instance for the players. For example, the host game functionality may send notifications to the players when it is their turn, present their submitted phrases on the game board 106, distribute new letters to a player's letter bank, keep track of a game score and so forth.

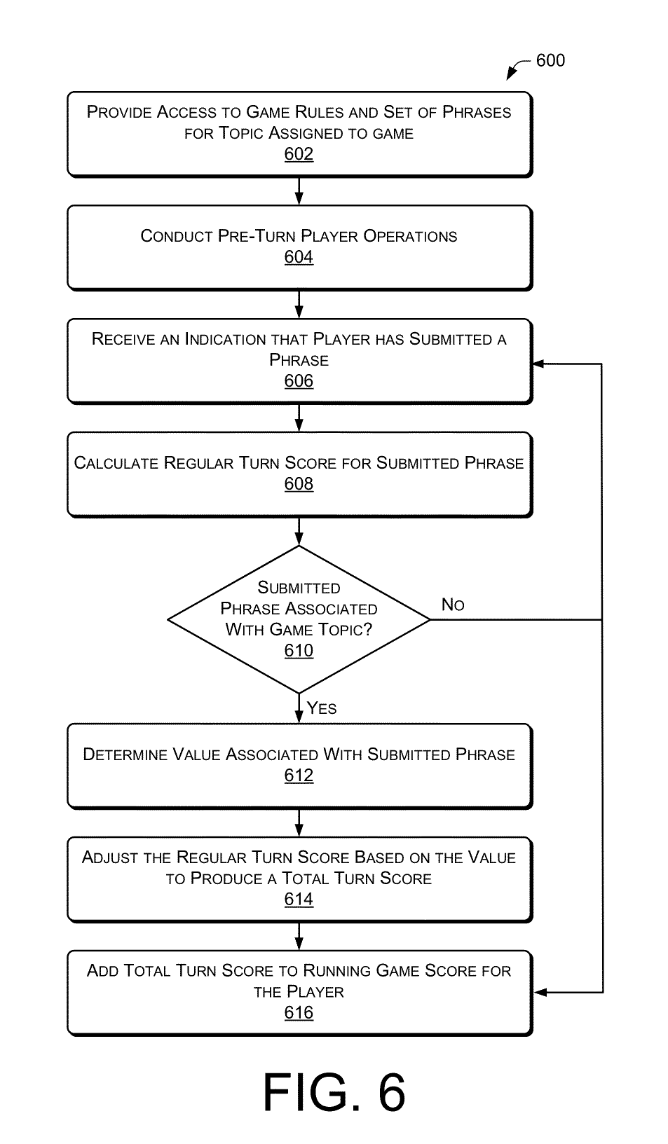

FIG. 6 illustrates an example process 600 that scores an individual turn for a player playing the topic related phrase game.

In at least one embodiment, at 602, the host game functionality 104 may provide player access to game rules and/or the set of phrases for the topic assigned to the gameplay instance. This may be done in response to receiving a request to view game information. For example, the host game functionality 104 may provide the complete list of phrases and their values, the host game functionality 104 may provide, for consideration by the players, factors used to assign values to phrases, or the host game functionality 104 may not provide any access to the phrases and/or values (e.g., the players have to guess whether a phrase played is associated with the topic and the players are informed of the bonus value after the phrase is submitted to the game board).

At 604, the host game functionality 104 may conduct pre-turn player operations. For example, a player may realize that if he/she had one additional letter, then he/she could spell a phrase with a higher value than another phrase he/she is able to play. Thus, the player may choose to purchase (e.g., using real money, game money, etc.) a blank letter (e.g., can be used as any letter) so the player can play the phrase with the higher value.

At 606, the host game functionality 104 receives an indication that a player has submitted a phrase to the game board 106.

At 608, the scoring module 214 calculates a regular turn score based on a combination of letters used in the phrase and/or any game-board location

At 610, the phrase mapping module 212 accesses phrase game database 220 to determine if the phrase submitted to the game board 106 is associated with (e.g., maps to) a phrase for the game topic assigned to the game. For instance, each of “fixes”, “fixed”, “fixing” may map the phrase “fix” in a topic phrase list and thus, the value assigned to “fix” may be used for the different forms of the phrase.

If “no” at 610, then the host game functionality 104 may determine that the regular turn score from operation 608 is the total turn score and may add the total turn score to a total, running game score for the player at 616 (e.g., the player does not earn a bonus based on a phrase association with a topic). In an alternative embodiment where each submitted phrase must be associated with the topic (in accordance with game rules 222), the host game functionality 104 may not accept the submitted phrase and may send a notification to the player to play another phrase and then the process returns to operation 606 where the host functionality receives an indication of another played phrase (e.g., after informing the player that the previous phrase is unacceptable).

If “yes” at 610, then at 612 the phrase mapping module 212 determines a value associated with the submitted phrase.

At 614, the scoring module 214 adjusts the regular turn score from operation 608 based on the value assigned to the phrase to produce a total turn score. For example, the scoring module 214 may multiply the regular turn score by a multiplier value associated with the phrase. In another example, the scoring module 214 may add a point value associated with the phrase to the regular turn score.

At 616, the scoring module 214 adds the total turn score to the total, running game score of the player.

The example process 600 of FIG. 6 may be repeated for each turn for each player accumulating points as the game goes on and until the game ends (e.g., no more letters to distribute to player letter banks, board is too full, etc.).

### CONCLUSION

Although the subject matter has been described in language specific to structural features and/or methodological acts, it is to be understood that the subject matter defined in the claims is not necessarily limited to the specific features or acts described above. Rather, the specific features and acts described above are described as example forms of implementing the claims.

What is claimed is:

1. A method comprising:
initiating a gameplay of a game where at least two players individually submit phrases to a game board to earn a score;
identifying a topic for the gameplay that includes a plurality of phrases individually assigned a value, the plurality of phrases being associated with the topic;
receiving an indication that a player has submitted a phrase to the game board;
accessing, by one or more processors, a database that maintains the plurality of phrases associated with the topic and the values individually assigned to the plurality of phrases;
determining that the phrase submitted to the game board maps to a phrase associated with the topic maintained in the database; and
adjusting the score of the player based at least in part on the value assigned to the phrase submitted to the game score.

2. The method of claim 1, wherein the score is a turn score and the value is a bonus value, the method further comprising:
determining the turn score based at least in part on at least one of letter values assigned to individual letters of the phrase or a location on the game board where the individual letters are placed;
adjusting the turn score of the player based at least in part on the bonus value to produce a total turn score; and
adding the total turn score to a total game score for the player.

3. The method of claim 2, wherein the bonus value comprises at least one of a multiplier of the turn score or a pre-defined amount of points to be added to the turn score.

4. The method of claim 1, wherein the values individually assigned to the phrases are pre-defined values assigned before the individual phrases are played during the gameplay.

5. The method of claim 1, wherein an individual phrase comprises a single word commonly used in association with the topic, two or more words commonly used in association with the topic, an acronym commonly used in association with the topic, one or more terms given a specific meaning that is commonly used in association with the topic, or an abbreviation commonly used in association with the topic.

6. The method of claim 1, wherein the identifying the topic for the gameplay comprises receiving a topic selection from a plurality of different topics from one of the at least two players before play begins.

7. The method of claim 1, wherein the identifying the topic for the gameplay comprises automatically assigning the topic without receiving user input.

8. The method of claim 1, further comprising recommending the topic to at least one player or automatically selecting the topic based on accessible user information, the user information including at least one of messaging information, social networking information, calendar information, gaming information, browsing information, Web searching information, image information, or purchase information.

9. The method of claim 1, wherein a value is individually determined for assignment to a phrase based on one or more factors comprising a difficulty of spelling the phrase, a number of letters in the phrase, or a difficulty of pronunciation.

10. The method of claim 1, wherein a value is individually determined for assignment to a phrase based on one or more factors comprising an element of popularity of the phrase associated with the topic, an element or commonality of the phrase associated with the topic, or a relevance of the phrase based on importance within the topic.

11. A method comprising:
receiving an identification of a topic of a phrase game;
determining a set of phrases associated with the topic of the phrase game;
receiving a value assigned to individual phrases in the set of phrases based on an association between an individual phrase and the topic of the phrase game; and
storing, by one or more processors, the set of phrases and the values assigned to the individual phrases in a database associated with the game.

12. The method of claim 11, further comprising:
creating a gameplay instance of the game for at least two players that alternate turns playing phrases to earn a game score;
accessing the database to determine if a played phrase correlates to an individual phrase listed in the set of phrases associated with the topic;
if the played phrase correlates to the individual phrase, determining the assigned value for the individual phrase correlated to the played phrase;
adjusting a turn score for the player score based on the assigned value to produce a total turn score; and
adding the total turn score to the game score.

13. The method of claim 11, wherein the values assigned to the individual phrases are provided by a developer of the game considering one or more factors, the one or more factors comprising a difficulty of spelling the phrase, a number of letters in the phrase, a difficulty of pronunciation, an element of popularity of the phrase associated with the topic, an element or commonality of the phrase associated with the topic, or a relevance of the phrase based on importance within the topic.

14. The method of claim 11, wherein the values are bonus values that adjust a regular turn score by at least one of multiplying the regular turn score by a multiplier or adding a pre-defined bonus points to the regular turn score.

15. The method of claim 11, wherein the determining the set of phrases associated with the topic comprises performing an online search for the topic or receiving user input.

16. One or more non-transitory computer-readable media comprising instructions that, when executed on one or more processors, perform acts comprising:
determining, during a gameplay instance of a phrase game, a regular turn score for a phrase that has been submitted by a player in turn;
mapping the phrase to a pre-defined bonus phrase score;
modifying the regular turn score based on the pre-defined bonus phrase score to produce a total turn score; and
adding the total turn score to a total game score for the player.

17. The one or more non-transitory computer-readable media of claim 16, wherein the pre-defined bonus phrase score is based at least in part on an association between the phrase and a topic defined for the gameplay of the phrase game.

18. The one or more non-transitory computer-readable media of claim 16, wherein:
the regular turn score of the phrase is calculated after the phrase is played based at least in part on a game board location of one or more letters in the phrase and individual points assigned to individual letters; and
the pre-defined bonus phrase score is a fixed score defined before the phrase is played.

19. The one or more non-transitory computer-readable media of claim 16, wherein the pre-defined bonus phrase score is a same bonus score for each instance of the phrase being played.

20. The one or more non-transitory computer-readable media of claim 16, wherein the pre-defined bonus phrase score modifies the regular turn score by at least one of multiplying the regular turn score by a bonus multiplier or adding a fixed amount of points to the regular turn score.
